(19) United States
(12) Patent Application Publication
(10) Pub. No.: US 2008/0219364 A1
(43) Pub. Date: Sep. 11, 2008

(54) DELAY-SENSITIVE CROSS LAYER SCHEDULER FOR MULTI-USER WIRELESS COMMUNICATION SYSTEMS

(75) Inventors: David Shui Wing Hui, Hong Kong (CN); Vincent Kin Nang Lau, Hong Kong (CN)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: THE HONG KONG UNIVERSITY OF SCIENCE AND TECHNOLOGY, Hong Kong (CN)

(21) Appl. No.: 12/030,412

(22) Filed: Feb. 13, 2008

Related U.S. Application Data
(60) Provisional application No. 60/894,123, filed on Mar. 9, 2007.

(51) Int. Cl. H04L 12/16

(52) U.S. Cl. 375/260

(57) ABSTRACT

CSIT error considerate delay-sensitive user access systems are provided in a multi-user OFDMA environment comprises a user delay sensitivity tracking component, a CSIT estimating component, a system queue state tracking component and a cross layer scheduling component. The techniques assume heterogeneous users with respect to delay and assume that CSIT information includes error, and optimally allocates broadcast resources, e.g., power, subcarriers and data rate, based on such assumptions.

### CROSS-REFERENCE TO RELATED APPLICATIONS

This application claims priority to U.S. Provisional Application Ser. No. 60/894,123, filed on Mar. 9, 2007, entitled “DELAY-SENSITIVE CROSS LAYER SCHEDULER SYSTEM AND METHOD”, the entirety of which is incorporated herein by reference.

### TECHNICAL FIELD

The subject disclosure generally relates to delay-sensitive cross layer scheduling for multi-user wireless communication systems that takes channel state information at transmitter (CSIT) error into account.

### BACKGROUND

Cross layer scheduling has been proposed to boost the spectral efficiency of multi-user digital transmission systems, such as multi-user Orthogonal Frequency Division Multiple Access (OFDMA) systems. As an example, OFDMA has been proposed as a way to support demand for high data rates by applications, such as wireless local area network (WLAN) applications and Worldwide Interoperability for Microwave Access (WIMAX) applications, i.e., applications based on the Institute of Electrical & Electronics Engineers (IEEE) wireless broadband standard 802.16.

However, conventional cross layer systems have been predicated upon various assumptions that are impractical in view of the way that multi-user wireless communication systems tend to be implemented and used in practice. First, conventional cross layer systems have assumed that users are delay insensitive. Second, conventional systems have assumed perfect CSIT information is always available.

As an exception to conventional systems that assume delay insensitivity, one cross layer scheduling algorithm, based on combined information theory and queuing theory, has considered delay sensitive real time users while seeking to minimize average system delay in a multi-access channel; however, such cross layer scheduling algorithm has assumed homogenous user delay requirements when it is likely applications will have heterogeneous requirements in reality.

While the problem of heterogeneity of delay constraints imposed by different applications has been considered in the context of OFDMA systems, such systems have assumed the availability of perfect CSIT information per the second assumption. The effect of CSIT error on scheduler design has been considered in certain limited contexts, such as in the context of orthogonal frequency division multiplexing (OFDM) systems and multi-user multiple-input single-output (MISO) systems; however, such proposals have limited their focus to power allocation design with limited CSIT feedback in an OFDM/frequency division duplex (FDD) system, without adequate consideration of the problem of outdated CSIT information.

In this regard, when the CSIT information is outdated, despite the use of strong channel coding, systematic packet errors result whenever the scheduled data rate exceeds the instantaneous mutual information. Due to such potential packet errors, conventional performance measures, such as ergodic capacity, become less meaningful because such measures fail to account for the penalty of packet errors.

Thus, conventional cross layer designs inadequately address the problem of outdated CSIT and ignore heterogeneous user delay requirements and queue dynamics. To the extent any conventional systems have attempted to address one or the other assumption, such treatment has been decoupled, i.e., no system has attempted to address both problematic assumptions together. Accordingly, as part of cross layer scheduling, it would be desirable to take outdated CSIT information into account and further desirable to consider users with heterogeneous delay sensitivities.

The above-described deficiencies of current cross layer designs are merely intended to provide an overview of some of the problems encountered with existing cross layer scheduler designs, and are not intended to be exhaustive. Other problems with the state of the art may become further apparent upon review of the description of various non-limiting embodiments that follows below.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

A CSIT error considerate delay-sensitive cross layer scheduler is provided that takes into account heterogeneous delay requirements in slow fading channels by utilizing queuing theory and information theory to model system dynamics. Various non-limiting embodiments of scheduling implemented by the scheduler account for the impact of outdated CSIT information in digital transmission systems. The scheduling optimizes allocation of power and allocation of subcarriers for multi-user OFDMA systems to maintain delay constraints of heterogeneous users, guarantee a fixed target outage probability, and provide asymptotic multi-user diversity gains over fixed allocation schemes.

In one embodiment, a CSIT error considerate delay-sensitive user access system for a multi-user OFDMA environment is provided that includes a user delay sensitivity tracking component, a CSIT estimating component, a system queue state tracking component and a cross layer scheduling component.

### BRIEF DESCRIPTION OF THE DRAWINGS

The various embodiments for CSIT error considerate delay-sensitive cross layer scheduling are further described with reference to the accompanying drawings in which:

FIG. 1 illustrates a flowchart of a general process for providing user access in a wireless communication system;

FIG. 2 is a simplified block diagram representing an exemplary system using a cross layer scheduler as described in various embodiments;

FIG. 3 is a block diagram representing an exemplary non-limiting multi-user OFDMA system and corresponding system model with heterogeneous application users in the presence of imperfect CSIT;

FIG. 4 illustrates one aspect of the comparative advantages of using an exemplary CSIT error considerate scheduler under conditions of CSIT error;

FIG. 5 illustrates a further aspect of the comparative advantages of using an exemplary CSIT error considerate scheduler under conditions of increased delay insensitive background traffic;

FIG. 6 illustrates a further aspect of the comparative advantages of using an exemplary CSIT error considerate scheduler in the presence of different conditions of CSIT error variance;

FIG. 7 is a flow diagram illustrating an exemplary, non-limiting process for scheduling from the perspective of users;

FIG. 8 is a flow diagram illustrating an exemplary, non-limiting process for scheduling from the perspective of a broadcast scheduler;

FIG. 9 is a block diagram of an example operating environment in which various aspects described herein can function; and

FIG. 10 illustrates an example wireless communication network in which various aspects described herein can be utilized.

### DETAILED DESCRIPTION

### Overview

A simplified overview is provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following of the overview is to present concepts related to some exemplary non-limiting embodiments in a simplified form as a prelude to the more detailed description of these and various other embodiments that follow.

As mentioned in the background, conventional cross layer systems have assumed that users are delay insensitive, and yet, at least some users are likely to have requirements, or sensitivity, when it comes to delay. In this regard, next generation networks are expected to contain real time users of heterogeneous classes with different delay requirements. As a result, in accordance with various embodiments described herein, users are assumed to be delay sensitive with heterogeneous delay requirements consistent with the evolution of wireless communications and disparate applications interacting across different users.

Conventional cross layer systems have also assumed that CSIT information is perfect. However, because a wireless channel is time varying, CSIT at the base station is already outdated when CSIT is estimated, e.g., from an uplink pilot in Time Division Duplexing (TDD) mode. In this regard, when CSIT information is outdated, systematic packet errors result even if powerful channel coding is applied, causing significant degradation of the delay performance of heterogeneous users. Accordingly, in accordance with various embodiments described herein, errors are presumed in CSIT information due to outdated information.

In one embodiment, a CSIT error considerate cross layer scheduling component determines optimal power, data rate, and subcarrier allocation for users of a digital transmission system with heterogeneous delay constraints in the presence of imperfect CSIT information. A user delay sensitivity component can be provided that determines and/or tracks the various heterogeneous users' delay constraints. Such information can then be considered when determining scheduling result(s) for users in a digital transmission system.

A CSIT estimating component can also be provided that estimates the system CSIT. Such information can then also be used for determining scheduling result(s) for users in a digital transmission system.

A system queue state tracking component can also be provided that determines and/or tracks the system queue state. The system queue state depends on such information as the amount of information remaining in each user's buffer in a digital transmission system. The system queue state information can then be used for determining scheduling result(s) in the digital transmission system.

A delay-sensitive cross layer scheduler can also be used to optimize spectral efficiency in the presence of heterogeneous delay requirements and imperfect CSIT simultaneously. To take account of heterogeneous delay requirements, both queuing theory and information theory can be used to model the system dynamics of a digital transmission system, including both the queue dynamics and the physical layer dynamics.

The CSIT error considerate delay-sensitive cross layer scheduler of the present invention can optionally be employed in a multi-user OFDMA system to boost spectral efficiency. In this regard, effective cross layer scheduling in OFDMA systems in accordance with embodiments described herein can be achieved through exploitation of multi-user diversity by carefully assigning multiple users to transmit simultaneously on different subcarriers for each OFDM symbol, along with optimal power and data rate allocations.

Simulated results illustrate that the delay-sensitive CSIT error considerate components and robust methodologies of the various embodiments provide a system performance enhancement over the performance of a naive scheduler, e.g., a scheduler that does not consider CSIT error, while satisfying heterogeneous delay requirements, even in the presence of moderate to relatively high amounts of error in CSIT information.

### Delay-Sensitive & CSIT Error Considerate Cross Layer Scheduling

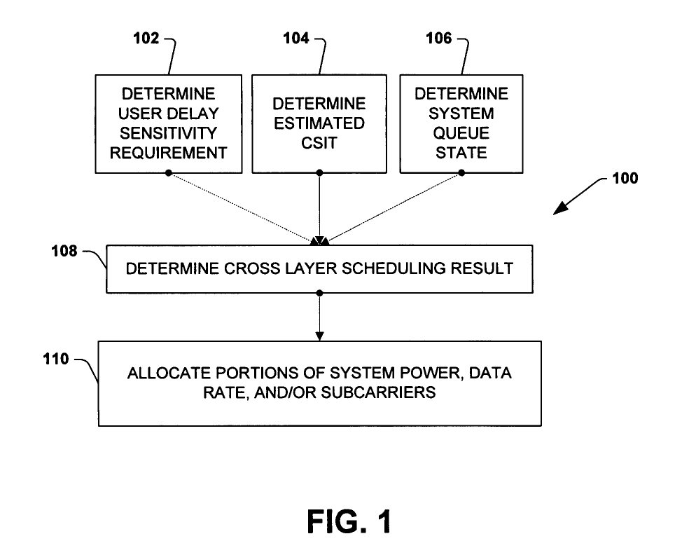

FIG. 1 is a flowchart of a general process of providing user access to a digital transmission system according to various non-limiting embodiments. A cross layer scheduling component 100, using inputs from at least a user delay sensitivity component 102, a CSIT estimating component 104, and a system queue state tracking component 106, determines a CSIT error considerate delay-sensitive cross layer scheduling result 108 and allocates system resources 110 according to framework provided herein.

The user delay sensitivity component 102 determines and/or tracks a user delay sensitivity requirement for one or more users of the digital transmission system. The CSIT estimating component 104 determines and/or tracks an estimated channel state information at the transmitter for the system. The system queue state tracking component 106 determines and/or tracks the system queue state.

The cross layer scheduling result(s) are determined at 108 for at least one user based, at least in part, on the system variables provided, i.e., user delay sensitivity requirement, the estimated channel state information at the transmitter, and the system queue state. Selective user access is then provided at 110 to one or more users of the at least one user by allocating portions of the system power, system data rate, and system subcarriers based, at least in part, on the respective determined cross layer scheduling result(s).

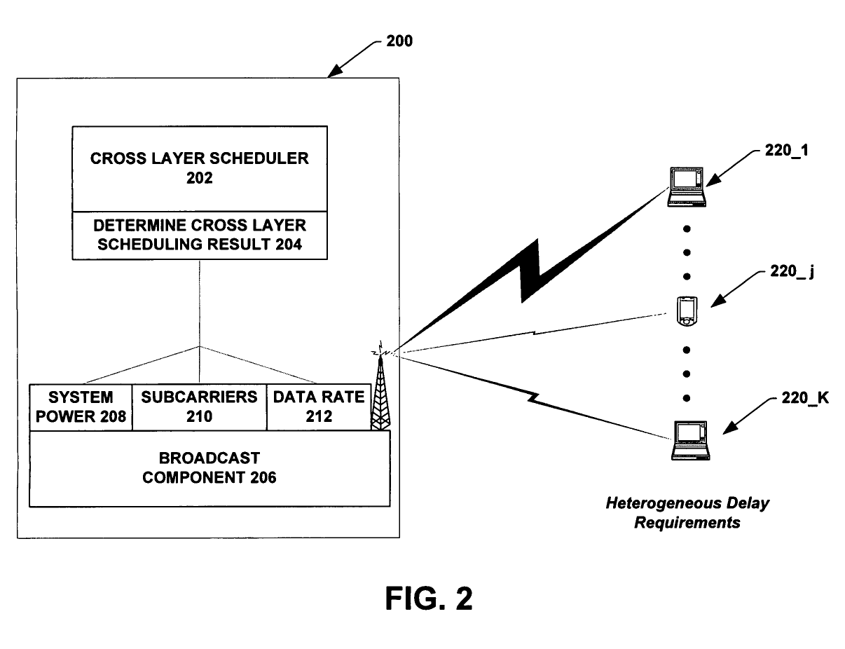

FIG. 2 is a simplified block diagram representing an exemplary system 200 using a cross layer scheduler component 202 as described in connection with various embodiments herein. Access by users 220_1, . . . , 220_{—}j, . . . , 220_K is provided by the broadcast component 206 based, at least in part, on the scheduling result 204, as determined by the cross layer scheduler component 202. The broadcast component 206 then broadcasts at optimized power 208, with optimal subcarriers 210 and optimized data rate 212. The broadcast component 206 thus dynamically changes its operation to achieve optimality for any given set of current conditions.

### Delay-Sensitive Cross Layer Scheduler

As mentioned, a delay-sensitive cross layer scheduler for a digital transmission system, such as a multi-user OFDMA system, as described herein, provides an effective balance between maximizing throughput and providing delay differentiation of heterogeneous users with robust performance even for medium to high levels of error in CSIT information. The cross layer scheduler has multi-user diversity gain that grows in a rate of log (K) with the number of users K and decreases proportionally with CSIT error variance σ_{ΔII}², while retaining substantial throughput gain over static allocation policy with the maintenance of all users' delay constraints, regardless of the variation of traffic loadings and CSIT error.

Based on the assumptions of heterogeneous users regarding delay, and imperfect CSIT information, the cross layer scheduler problem is formulated herein as an optimization problem that considers the imperfect CSIT information, source statistics and queue dynamics of the OFDMA systems. In this regard, the cross layer scheduling accounts for the heterogeneous delay requirements in slow fading channels as well as the imperfect CSIT simultaneously. The delay sensitive aspect of the cross layer scheduler design is thus coupled to handling the effect of imperfect of CSIT information.

As presented in further detail below, to take account of heterogeneous delay requirements, both queuing theory and information theory can be used to model the system dynamics (involving both the queue dynamics and the physical layer dynamics). A convex optimization problem is then formulated after proper transformation of the delay constraints, and the optimal delay-sensitive rate, power and subcarrier allocation solutions can be derived by incorporating the outdated CSIT accordingly.

The optimal power allocation and subcarrier allocation solutions can thus be obtained based on the optimization framework presented herein. Also, as mentioned, when there is imperfect CSIT, there are systematic packet errors, which have a significant impact on the delay performance of heterogeneous users. In contrast, the delay performance of naive cross layer schedulers, e.g., a CSIT error inconsiderate scheduler, designed under the assumption of perfect CSIT are very sensitive to CSIT errors.

In one non-limiting embodiment, optimal delay-sensitive power allocation employs a multi-level water-filling structure or abstraction where users with stringent delay constraint(s) and/or packet error (outage) requirements are assigned a higher “water-level” than users with fewer constraint(s)/requirements.

The optimal delay-sensitive subcarrier assignment in the presence of CSIT error is decoupled among subcarriers and hence has linear complexity with respect to the number of users. Asymptotic multi-user diversity gain using the delay-sensitive scheduler of the present invention are also analyzed below. In addition, by considering CSIT error statistics in the various cross layer scheduling embodiments, some non-limiting simulated results are presented that show a robust, advantageous performance enhancement and simultaneous satisfaction of heterogeneous delay requirements of users even at moderate to high CSIT error levels.

### Delay-Sensitive Cross Layer Scheduler Design Framework

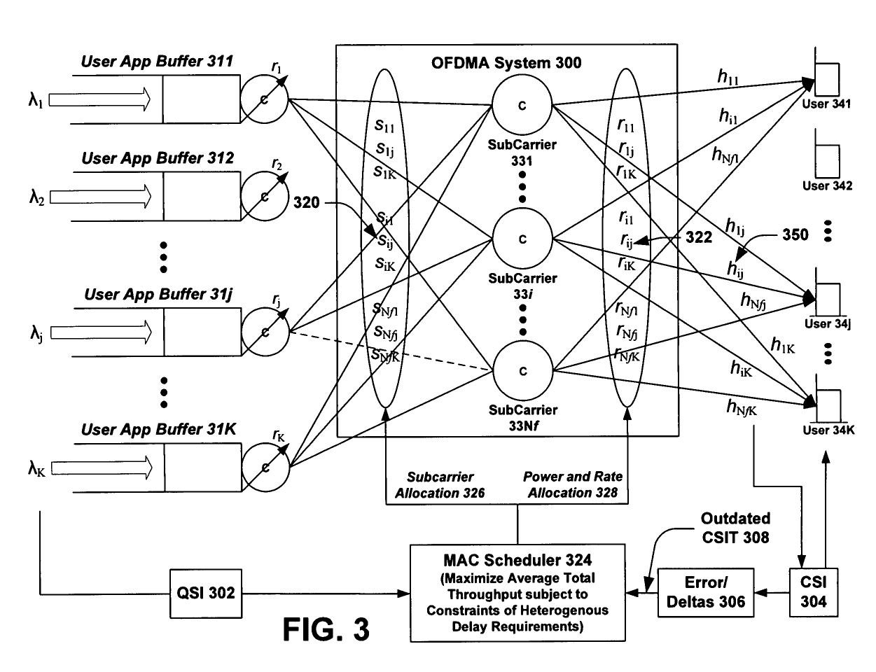

Referring to FIG. 3, a representative OFDMA system model 300 is constructed for a delay-sensitive cross layer scheduler design framework, and then, cross layer optimization problem is formulated based on the model 300. As shown, cross-layer system model 300 is used for multi-user downlink OFDMA scheduling system with N_{f} subcarriers 331, . . . , 33i, . . . , 33N_{f} for K heterogeneous application buffers 311, 312, . . . , 31j, . . . , 31K corresponding to K heterogeneous applications and K users 341, 342, . . . , 34j, . . . , 34K and imperfect CSIT 308 based on errors 306 from true CSI 304 is detailed below. Based on queuing state information 302 and outdated CSIT 308, MAC scheduler 324 determines optimal allocation of subcarriers 326 and optimal allocation of power and rate 328.

### Downlink Channel Model

Referring again to FIG. 3, an exemplary downlink channel model is shown for an OFDMA system with quasi-static fading channel within a scheduling slot, e.g., 2 ms. 2 ms is a reasonable assumption for users with pedestrian mobility where the coherence time of the channel fading is around 20 ms or more. For OFDMA systems, the N_{f} subcarriers 331, . . . , 33i, . . . , 33N_{f} are decoupled.

Let i denote the subcarrier index and j denotes the user index. The received symbol Yᵢⱼ at j^{th} mobile user 34j on i subcarrier 33i is:

Yᵢⱼ=hᵢⱼXᵢⱼ+Zᵢⱼ

where Xᵢⱼ is the data symbol from the base station to the j^{th} mobile user 34j on subcarrier i 33i, hᵢⱼ 350 is the complex channel gain of i^{th} subcarrier 33i for the j^{th} mobile user 34j which is independently and identically distributed (i.i.d.) zero mean complex Gaussian with unit variance and Zᵢⱼ is the zero mean complex Gaussian noise with unit variance.

Further, the transmit power allocated at 328 from the base station to user j 34j through subcarrier i 33i is given by pᵢⱼ=E[|Xᵢⱼ|²]. The subcarrier allocation strategy is S_{N}_{_{F}}_{×K}=[sᵢⱼ], where sᵢⱼ=1 when user j 34j is selected for subcarrier i 33i, otherwise sᵢⱼ=0. The average total transmit power of the base station is:

$$E [ {\sum }_{j = 1}^{K} {\sum }_{i = 1}^{{N}_{F}} {s}_{ij} {p}_{ij} ] \leq {P}_{TOT} ,$$

where P_{TOT} is the available total average power in the base station.

### CSIT Error Model

Referring again to FIG. 3, assuming a TDD system, due to channel reciprocity between uplink and downlink, the downlink CSIT at the base station is estimated from uplink dedicated pilots sent by all K mobiles 341, . . . , 34K. As the base station downlink pilot can be shared by all K users 341, . . . , 34K, the pilot power is usually larger and the CSIR at the mobiles 341, . . . , 34K is usually of a much smaller error variance compared with the CSIT at the base stations. Hence, for simplicity, mobiles 341, . . . , 34K are assumed to have perfect CSIR. The estimated CSIT {ĥᵢⱼ} for all users over all subcarriers 331, . . . , 33N_{f} at the base station can be modeled as:

ĥᵢⱼ=hᵢⱼ+Δhᵢⱼ

where {Δhᵢⱼ} are i.i.d. Gaussian random variables with zero mean and variance σ_{ΔH}². Assuming minimum mean squared error (MMSE) estimation, the CSIT error Δhᵢⱼ and ĥᵢⱼ are uncorrelated, i.e.:

E[Δhᵢⱼĥᵢⱼ]=0.

### Multi-User Physical Layer Model for OFDMA Systems, Packet Outage and Goodput Modeling

Information theoretical capacity is used as the abstraction of the multi-user physical layer model in order to decouple the problem from specific implementation of coding and modulation schemes. Shannon's capacity can be achieved by random codebook and Gaussian constellation at the base station. Hence, again with respect to FIG. 3, the maximum achievable data rate cᵢⱼ of user j 34j transmitted through subcarrier i 33i during the current fading slot is given by the maximum mutual information between Xᵢⱼ and Yᵢⱼ given by CSIT ĥᵢⱼ, which is given by:

$${c}_{ij} = {max}_{p ( {X}_{ij} )} I ( {X}_{ij} ; {Y}_{ij} \vert {h}_{ij} ) = log ( 1 + {p}_{ij} {\vert {h}_{ij} \vert}^{2} ) ,$$

where I(Xᵢⱼ;Yᵢⱼ|hᵢⱼ) denotes the conditional mutual information. This maximal achievable rate is a function of the CSIT hᵢⱼ which is unknown to the base station. Hence, given any estimated CSIT ĥᵢⱼ, some uncertainty remains on actual capacity cᵢⱼ, and packet transmission outage is possible when the scheduled data rate rᵢⱼ (bits/s/Hz) 322 exceed actual capacity. Accounting packet outage, instantaneous goodput (which measures the total instantaneous bits/s/Hz successfully delivered to user j) of j^{th} user 34j is defined as:

$${ρ}_{j} = {\sum }_{i = 1}^{{N}_{F}} {r}_{ij} I [ {r}_{ij} \leq {c}_{ij} ] , \\ where I [ {r}_{ij} \leq {c}_{ij} ] = \{ \begin{matrix}1 & if {r}_{ij} \leq {c}_{ij} \\ 0 & if {r}_{ij} > {c}_{ij}\end{matrix}$$

Hence, average goodput of user j ρ̅ⱼ=E_{H}[ρⱼ] (averaged over ergodic realizations of H={hᵢⱼ} and Ĥ={ĥᵢⱼ}) is given by:

$$\begin{matrix}{\overline{ρ}}_{j} = {E}_{\hat{H}} \{ {E}_{H \vert \hat{H}} [ {\sum }_{i = 1}^{{N}_{F}} {r}_{ij} I [ {r}_{ij} \leq {c}_{ij} ] ] \} \\ = {E}_{\hat{H}} \{ {\sum }_{i = 1}^{{N}_{F}} {r}_{ij} {E}_{H \vert \hat{H}} [ I [ {r}_{ij} \leq {c}_{ij} ] ] \} \\ = {E}_{\hat{H}} \{ {\sum }_{i = 1}^{{N}_{F}} {r}_{ij} Pr ( {r}_{ij} \leq {c}_{ij} \vert \hat{H} ) \} \\ = {E}_{\hat{H}} \{ {\sum }_{i = 1}^{{N}_{F}} {r}_{ij} ( 1 - {P}_{out , i} ) \}\end{matrix}$$

where P_{out,i}=1−Pr(rᵢⱼ≦cᵢⱼ|Ĥ) is the packet outage probability conditioned on the CSIT realization Ĥ.

### Source Model

Referring again to FIG. 3, packets are assumed to come into each user j's buffer 31j according to a Poisson process with independent rate λⱼ and with fixed packets size F. The heterogeneous nature of each user application is characterized by the K tuples [λⱼ,Tⱼ], where Tⱼ is the j delay constraint requirement by the user j 34j. Users 341, . . . , 34K with a heavier traffic load will thus have a higher λⱼ and an application highly sensitive to delay will have a stringent delay requirement Tⱼ.

### Mac Layer Model

With further reference to FIG. 3, the system dynamics are characterized by system state χ=(Ĥ_{N}_{_{F}}_{×K},Q_{K}), which consists of estimated CSIT Ĥ_{N}_{_{F}}_{×K} 308 and queue state Q_{K} at 302, where Q_{K}=[qⱼ] is a K×1 vector with the j^{th} component denoting the number of packets remaining user j's buffer 34j. The MAC layer 324 is responsible for the cross-layer scheduling channel resource allocation at 326 and 328 at the fading blocks based on the current system state χ. At the beginning of each frame, the base station estimates the CSIT from uplink pilots. Based on imperfect CSIT 308 and queue states 302, the scheduler 324 determines the subcarrier allocation 326 from policy S_{N}_{_{F}}_{×K}[Ĥ,Q], the power allocation 328 from policy P_{N}_{_{F}}_{×K}[Ĥ, Q], and the corresponding rate allocation 328 from R_{N}_{_{F}}_{×K}[Ĥ,Q] for the selected user of users 341, . . . , 34K. The scheduling results are then broadcast on downlink common channels to all mobile users 341, . . . , 34K before subsequent downlink packets transmit at scheduled rates.

### Cross Layer Problem Formulation

Referring again to FIG. 3, the OFDMA cross layer design for heterogeneous users 341, . . . , 34K with imperfect CSIT at 308 can be formulated as a constrained optimization problem based on the system model introduced above. By adopting the total average system goodput,

$${\sum }_{j = 1}^{K} {\overline{ρ}}_{j}$$

as the optimization objective to account for potential packet outage, the cross layer problem can be formulated as follows.

Find optimal rate, subcarrier, and power allocation policies (R_{N}_{_{F}}_{×K}[Ĥ,Q],(R_{N}_{_{F}}_{×K}[Ĥ,Q],S_{N}_{_{F}}_{×K}[Ĥ,Q],P_{N}_{_{F}}_{×K}[Ĥ,Q]) such that:

$${max}_{S , P , R} E ( {\sum }_{i = 1}^{{N}_{F}} {\sum }_{j = 1}^{K} {r}_{ij} Pr ( {r}_{ij} \leq {c}_{ij} \vert \hat{H} ) )$$

$$\begin{matrix}subject to & ( C 1 ) \text{:} {s}_{ij} ∈ \{ 0 , 1 \} , ( C 2 ) \text{:} {\sum }_{j = 1}^{K} {s}_{ij} = 1 \\ & ( C 3 ) \text{:} {p}_{ij} \geq 0 , ( C 4 ) \text{:} E [ {\sum }_{j = 1}^{K} {\sum }_{i = 1}^{{N}_{F}} {s}_{ij} {p}_{ij} ] \leq {P}_{TOT} \\ & ( C 5 ) \text{:} {P}_{out , i} = ɛ , ( C 6 ) \text{:} E [ {\tilde{W}}_{j} ] \leq {T}_{j} , ∀ χ , i , j\end{matrix}$$

where expectation E[.] is taken over all system state χ=(Ĥ_{N}_{_{F}}_{33 K},Q_{K}) and P_{TOT} is the average power constraint.

In the optimization problem above, constraints (C1) and (C2) are used to ensure only one user 34j can occupy a subcarrier i 33i at one time. Constraint (C3) is used to ensure transmit power would only take positive value, (C4) is the average total power constraint, (C5) is to ensure the outage probability ε specified by applications requirements and (C6) is the average delay constraint where E[\tilde{W}ⱼ] is the system time (including waiting time and service time) of user j 34j.

### Relationship Between Scheduled Data Rate and Delay Parameters

Before the optimization problem above can be solved, the delay constraint (C6) is expressed in terms of physical layer parameters according to the following lemma from queuing analysis:

Lemma 1: A necessary and sufficient condition for the constraint (C6) is

$$E [ {W}_{j} ] = E [ {X}_{j} ] + \frac{{λ}_{j} E [ {X}_{j}^{2} ] + {λ}_{j} E [ {X}_{j} ] ( E [ \overline{{S}_{j}} ] / E [ {S}_{j} ] ) ( {t}_{s} )}{2 ( 1 - {λ}_{j} ( E [ {X}_{j} ] / E [ {S}_{j} ] ) )} \leq {T}_{j}$$

where Xⱼ is the service time of the packet of user j 34j, Δⱼ is the arrival rate 31j of user j 34j, Tⱼ is the average delay requirement of user j 34j, tₛ is the duration of the scheduling slot. Sⱼ and S̅ⱼ̅ are indicator variables for availability and unavailability of subcarriers 331, . . . , 33N_{f} for user j 34j respectively, i.e. (sⱼ(m)=1, s̅ⱼ̅(m)=0) if there is a subcarrier 331, . . . , 33N_{f} allocated to user j 34j at time slot index m; (sⱼ(m)=0, s̅ⱼ̅(m)=1) if none of the N_{f} subcarriers 331, . . . , 33N_{f} are assigned to user j 34j at time slot index m.

From Lemma 1, the constraint (C5) can be transformed to an equivalent rate constraint that directly relates scheduled data rate Rⱼ of user j 34j to the user characteristic tuple [λⱼ, Tⱼ], and also the packet size F.

Corollary 1: A necessary and sufficient condition for the constraint (C6) when Tⱼ→∞ is E[SⱼRⱼ](1−P_{out,i})≧Fλⱼ.

This corollary shows that average effective scheduled data rate E[SⱼRⱼ](1−ε) of user j 34j (with P_{out,i}=ε accounted) should be at least the same as bits arrival rate to user j's queue at 31j (regardless of the delay concerned) in order to guarantee stability of the queue.

Corollary 2: A necessary and sufficient condition for the constraint (C6), called the equivalent rate constraint, is given by E(SⱼRⱼ)(1−P_{out,i})≧ρⱼ(λⱼ,Tⱼ,F) where

ρⱼ(λₙ,Tⱼ,F)=((2Tⱼλⱼ+2)+\sqrt{(2Tⱼλⱼ+2)²+8Tⱼλⱼ})(F/4Tⱼ)

Lemma 1 differs from standard Pollaczek-Khinchin formula for delay modeling in fixed line system in two ways. Specifically, in the present invention, the effects of packet errors (and retransmission) as well as the effect of users not being selected in the current time slot have to be addressed in the framework.

### Scheduling Strategies

The optimization problem is a mixed combinatorial (in {sᵢⱼ}) 320 and convex (in {pᵢⱼ}) optimization problem. One possible solution to the optimization problem is to first fix each sᵢⱼ 320 and solve convex sub-problem in {pᵢⱼ}, and then exhaustively search through {sᵢⱼ} 320 for the one that gives largest goodput

$${\sum }_{i = 1}^{{N}_{F}} {\sum }_{j = 1}^{K} {r}_{ij} ( 1 - {P}_{out , i} ) .$$

However, the total search space in this way is N_{f}^{K} which is computationally very inefficient even for moderate N_{f}. The search for optimal {sᵢⱼ} 320 can be decoupled between the N_{f} subcarriers 331, . . . , 33N_{f} and hence, only with complexity N_{f}×K only.

### Optimal Delay-Sensitive Subcarrier, Power and Rate Allocation (Matched to the CSIT Errors)

Given any CSIT estimate ĥᵢⱼ, the actual CSIT ĥᵢⱼ is Gaussian distributed with mean and variance given by E_{h|ĥ}[hᵢⱼ|ĥᵢⱼ]=ĥᵢⱼ and E_{h|ĥ}[(hᵢⱼ−hᵢⱼ)*(hᵢⱼ−ĥᵢⱼ)|ĥᵢⱼ]=σ_{ΔII}², respectively. Hence, |hᵢⱼ|²/σ_{ΔII} is a non-central chi-square random variable with two degrees of freedom and non-central parameter θ=|ĥᵢⱼ|²/σ_{ΔH}² having c.d.f F_{χ}_{₂}_{²}_{(θ)}(x). To satisfy a target outage probability ε, the rate allocation policy R_{N}_{_{F}}_{×K}=[rᵢⱼ] is given by:

rᵢⱼ=log₂(1+pᵢⱼφᵢⱼ|ĥᵢⱼ|²), where φᵢⱼ=F_{χ}_{₂}_{²}_{(θ)}(ε)/θ

From corollary 2 and the above equation, the optimization problem can be reformulated as follows:

$${max}_{S \text{:} \{ {s}_{ij} ∈ \{ 0 , 1 \} , {\sum }_{j = 1}^{K} {s}_{ij} = 1 \} , P \text{:} \{ {p}_{ij} \geq 0 \}} E [ {\sum }_{i = 1}^{{N}_{F}} {\sum }_{j = 1}^{K} {s}_{ij} ( 1 - ɛ ) {log}_{2} ( 1 + {p}_{ij} {ϕ}_{ij} {\vert {\hat{h}}_{ij} \vert}^{2} ) ]$$

$$\begin{matrix}subject to & ( C 4 ) \text{:} E [ {\sum }_{j = 1}^{K} {\sum }_{i = 1}^{{N}_{F}} {s}_{ij} {p}_{ij} ] \leq {P}_{TOT} \\ & ( C 5 ) \text{:} E [ {\sum }_{i = 1}^{{N}_{F}} {s}_{ij} ( 1 - ɛ ) {log}_{2} ( 1 + {p}_{ij} {ϕ}_{ij} {\vert {\hat{h}}_{ij} \vert}^{2} ) ] \geq {ρ}_{j}^{′}\end{matrix}$$

where σ′ⱼ(λⱼ,Tⱼ,F)=σⱼ(λⱼ,Tⱼ,F)/(BW/N_{F}), and BW is the total bandwidth of the OFDM system.

This optimization problem is also a mixed integer and convex optimization problem. In order to make the problem more traceable, constraint (C1) is replaced to let the integer sᵢⱼ be further relaxed to be a sharing factor sᵢⱼ∈[0,1] (indicating the fraction of time that the user j 34j would have to occupy the subcarrier i 33i) and set \tilde{p}ᵢⱼ=pᵢⱼsᵢⱼ, so optimization the problem above is reformulated as a convex optimization problem. Using Lagrange Multiplier techniques, the following Lagrangian is obtained:

$$L = {\sum }_{j = 1}^{K} {\sum }_{i = 1}^{{N}_{f}} {s}_{ij} ( 1 - ɛ ) {log}_{2} ( 1 + \frac{{\tilde{p}}_{ij} {ϕ}_{ij} {\vert {\hat{h}}_{ij} \vert}^{2}}{{s}_{ij}} ) - μ ( {\sum }_{j = 1}^{K} {\sum }_{i = 1}^{{N}_{f}} {\tilde{p}}_{ij} - {P}_{TOT} ) + {\sum }_{j = 1}^{K} ( {γ}_{j} {s}_{ij} ( 1 - ɛ ) {log}_{2} ( 1 + \frac{{\tilde{p}}_{ij} {ϕ}_{ij} {\vert {\hat{h}}_{ij} \vert}^{2}}{{s}_{ij}} ) - {ρ}_{j}^{′} ) + {\sum }_{i = 1}^{{N}_{f}} {φ}_{i} ( {\sum }_{i = 1}^{{N}_{f}} {s}_{ij - 1} )$$

where μ≧0, γⱼ≧0, φᵢ are Lagrange multipliers. After finding KKT conditions through this Lagrangian, the following optimal power and subcarrier allocation is stated in Theorem 1.

Theorem 1: Given the CSIT realization Ĥ=[ĥᵢⱼ], the optimal subcarrier allocation Sₒₚₜ(Ĥ)=[sᵢⱼ] can be decoupled between N_{f} subcarriers 331, . . . , 33N_{f} and is given by:

$$\begin{matrix}For i = 1 \text{:} {N}_{F} \\ {j}^{*} = {arg max}_{j ∈ [ 1 , K ]} \{ {{c}_{j} ( {log}_{2} ( {c}_{j} {ϕ}_{ij} {\vert {\hat{h}}_{ij} \vert}^{2} ) )}^{+} - {( {c}_{j} - \frac{1}{{ϕ}_{ij} {\vert {\hat{h}}_{ij} \vert}^{2}} )}^{+} \} \\ {s}_{ij} = \{ \begin{matrix}1 , & j = {j}^{*} \\ 0 , & otherwise\end{matrix} \\ END\end{matrix}$$

The corresponding optimal power allocation Pₒₚₜ(Ĥ)=[pᵢⱼ]

$${p}_{ij} = \{ \begin{matrix}{( {c}_{j} - 1 / ( {ϕ}_{ij} {\vert {\hat{h}}_{ij} \vert}^{2} ) )}^{+} , & ∀ {s}_{ij} = 1 \\ 0 , & otherwise\end{matrix}$$

where cⱼ=(1+γⱼ)(1−ε)/μ is called the water-level of user j 34j and where (x)⁺ [symbol] max(0,x).

In Theorem 1, the subcarrier allocation strategy above can be implemented by a greedy algorithm with linear complexity of K, and the optimal power allocation Pₒₚₜ(Ĥ)=[pᵢⱼ] can be interpreted as a multi-level water-filling strategy. This means that those users 341, . . . , 34K with urgent packets have to transmit at a higher power level (depending on the urgency), while non-urgent users, i.e., those users with average delay strictly less than a delay deadline, are allocated with the same power level. A more stringent target outage probability requirement can also lead to a higher water-level.

It is noted that some user requirement specifications may not lead to a feasible solution to the above derived reformulated optimization problem. The minimum required power Pₘᵢₙ to support delay constraints for all users specified in the above reformulated optimization problem is given by:

$${P}_{min} = E [ {\sum }_{i = 1}^{{N}_{F}} {\sum }_{j = 1}^{K} {{s}_{ij} ( {c}_{j} - 1 / {ϕ}_{ij} {\vert {\hat{h}}_{ij} \vert}^{2} )}^{+} ] ,$$

where cⱼ is the solution to:

$$E [ {\sum }_{i = 1}^{{N}_{F}} {s}_{ij} {log ( {c}_{j} {ϕ}_{ij} {\vert {\hat{h}}_{ij} \vert}^{2} )}^{+} ] = {ρ}_{j}^{′} , ∀ j ,$$

i.e., all users' equivalent rate requirements ρ′ⱼ are barely satisfied.

Supposing P_{TOT}≧Pₘᵢₙ, the Lagrange multipliers μ, γⱼ can be found iteratively by first fixing μ, then finding the corresponding γⱼ for all j 34j based on known algorithms, and then μ is updated based on the power consumption using γⱼ. The process iterates until the following systems of equations are satisfied:

$$\{ \begin{matrix}E [ {\sum }_{i = 1}^{{N}_{F}} {\sum }_{j = 1}^{K} {{s}_{ij} ( ( 1 + {γ}_{j} ) ( 1 - ɛ ) / μ - 1 / {ϕ}_{ij} {\vert {\hat{h}}_{ij} \vert}^{2} )}^{+} ] = {P}_{ToT} \\ {γ}_{j} [ E [ {\sum }_{i = 1}^{{N}_{F}} {{s}_{ij} ( log ( ( ( 1 + {γ}_{j} ) ( 1 - ɛ ) / μ ) {ϕ}_{ij} {\vert {\hat{h}}_{ij} \vert}^{2} ) )}^{+} ] - {ρ}_{j}^{′} ] = 0 , ∀ j\end{matrix}$$

Asymptotic Multiuser Diversity Gain

As mentioned, multi-user diversity gain of cross layer OFDMA schedulers have been studied without delay constraints and having assumed availability of perfect CSI. The order of growth of multi-user diversity gain is indicated as Θ(ln(K)) as K→∞. The multi-user diversity gain using scheduler in accordance with embodiments described herein under heterogeneous delay constraints and imperfect CSIT is shown below, in connection with an OFDMA system with K users 341, . . . , 34K is considered (K₁ delay sensitive Class 1 users and K₂ delay insensitive Class 2 users).

Given P_{TOT}≧Pₘᵢₙ, with large number of users K (=K₁+K₂), the following lemma summarizes the multi-user diversity gain by the scheduler of the present invention for an OFDMA system.

Lemma 2: For large number of users K₁ and K₂, with fixed equivalent rate requirements ρ′₁ and ρ′₂, the conditional multi-user diversity gain for both class 1 and 2 (represented as a function of σ_{ΔII}²<1) is given by:

$$\begin{matrix}E [ {s}_{ij} {ϕ}_{ij} {\vert {\hat{h}}_{ij} \vert}^{2} \vert {s}_{ij} = 1 , j ∈ a particular class ] \\ = Θ ( ( 1 - {σ}_{Δ H}^{2} ) ln ( K ) ) ,\end{matrix}$$

$$where$$

$${a}_{K} • Θ ( {b}_{K} ) if lim {sup}_{K \to ∞} \frac{\vert {a}_{K} \vert}{\vert {b}_{K} \vert} < ∞ \& lim {sup}_{K \to ∞} \frac{\vert {b}_{K} \vert}{\vert {a}_{K} \vert} < ∞$$

The effect of the scheduler of the present invention upon multi-user diversity gain (for the case of K₂=MK₁,K₁→∞ where M is a constant) is clear from the intuition brought by Lemma 2, noting the impact of the two practical factors addressed (e.g., the heterogeneous delay requirements and imperfect CSIT).

Impact of heterogeneous class: Embodiments of the scheduler can still retain the same order of multi-user diversity gain Θ(ln(K)) as K→∞, even after the heterogeneous delay constraints are imposed. This is because advantageously, each subcarrier 331, . . . , 33Nf is assigned to the best user from Class 1 and Class 2. Since the best user within class g is chosen according to a purely opportunistic scheduler, the conditional multi-user diversity gain over a static scheduler (conditioned on class g) is given by ln(K_{g}) as is shown for single class scheduling.

Impact of imperfectness of CSIT: Since the factor F_{χ}_{₂}_{²}_{(θ)}⁻¹(ε), which depends on the mean of the c.d.f. F_{χ}_{₂}_{²}_{(θ)}(x), grows in the same rate as the noncentral parameter θ, it will not affect the resultant order of growth of multi-user diversity gain, and the conditional multi-user diversity gain is expressed in Lemma 2 as E[φ_{ij*}|ĥ_{ij*}|²]=Θ((1−σ_{ΔH}²)ln(K)). In one extreme case, when σ_{ΔH}²=0 (perfect CSIT), the multi-user diversity gain is given by ln(K); in the other extreme case when σ_{ΔH}²→1 (no CS IT), the factor (1−σ_{ΔH}²)→0 and hence, the multi-user diversity gain approaches zero as expected. In general, for intermediate CSIT errors, the multi-user diversity gain decreases linearly as σ_{ΔH}² increases. This is because the scheduler can use the estimated CSIT, which has variance of E[|ĥᵢⱼ|²]=1−σ_{ΔH}², to perform multi-user selection. Thus, after exploiting the multi-user diversity, the conditional signal to noise ratio (SNR) of a selected user 341, . . . , 34K is E[|ĥ_{ij*}|²]=(1−σ_{ΔH}²)ln(K).

### Results Provided by the Cross-Layer Scheduler

Simulated results of the above embodiments can be shown using Monte Carlo simulation to illustrate the performance of the cross layer scheduler for OFDMA systems with heterogeneous applications in the presence of CSIT error. The CSIT error considerate scheduler of the present invention is compared with the performance the CSIT error inconsiderate scheduler, e.g., the ideal scheduler assuming availability of perfect CSIT, which treats the outdated CSIT estimate as perfect CSIT, otherwise referred to as a naive scheduler, and the conventional baseline reference—static power and subcarrier assignment.

An OFDMA system is considered with total system bandwidth of 1.024 MHz consisting of 64 subcarriers 331, . . . , 33N_{f} and 5 users 341, . . . , 34K having 5 independent paths. The duration of a scheduling slot is assumed to be 2 ms an all mobile users 341, . . . , 34K suffer the same the path loss from the base station. The target outage probability of each subcarrier 331, . . . , 33N_{f} is set to P_{out, i}=0.01. Two classes of users 341, . . . , 34K are considered in the system 300, with arrival rates 311, . . . , 31K and delay requirements of each class being specified by:

(λ,T)={(λ₁,T₁),(λ₂,T₂)} (packets per time slot, time slots).

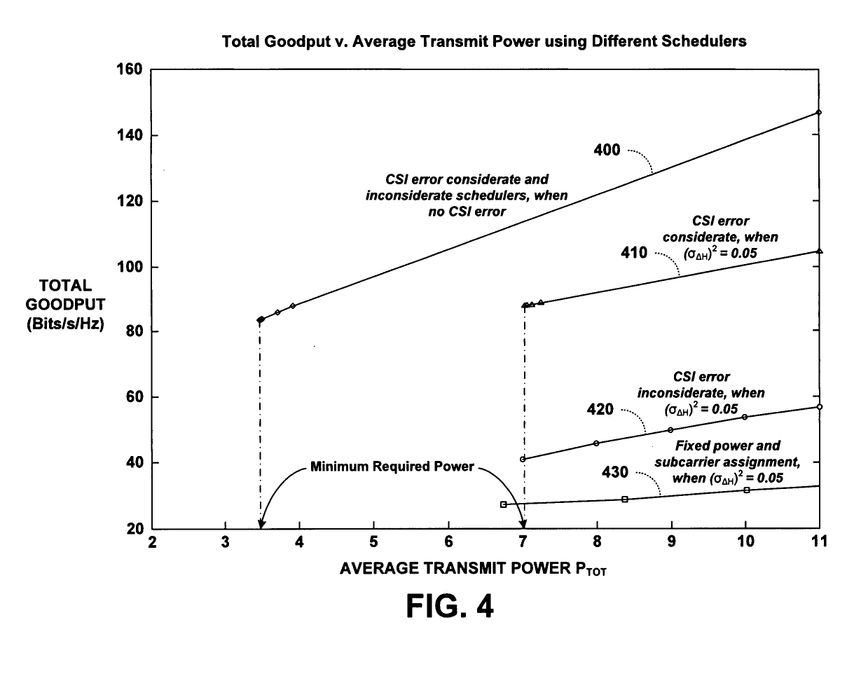

The system also contains some unclassed users having no delay constraint (with requirements of 1000 time slots). Each packet consists of 1.024 kbits and each point in FIGS. 4-6 is simulated from 5000 independent trials.

Referring to FIG. 4, the model compares the average goodput versus the available average transmit power for an exemplary OFDMA system, using the scheduler as described herein and other known scheduling algorithms. Observing curve 400 representing conditions of no CSIT error, the CSIT error inconsiderate (nominally ideal) scheduler exhibits substantial goodput gain compared with the fixed power and subcarrier allocation scheme. However, under very small CSIT error (σ_{ΔH}²=0.05), its goodput performance of degrades significantly as observed by curve 420, not much better than curve 430 representing fixed power and subcarrier assignment as a floor for comparison. In contrast, substantial goodput gain (over fixed assignment policy curve 430) is retained by using the CSIT error considerate scheduler as represented by curve 410.

Furthermore, FIG. 4 shows that the minimum required power supporting all delay constraints of the user increases as error variance σ_{ΔH}² increases from 0 to 0.05. The results show that by comparison with the scheduler as described herein, the CSIT error inconsiderate scheduler and fixed scheduler provide undesirable performance with respect to delay for classed users within average transmit power.

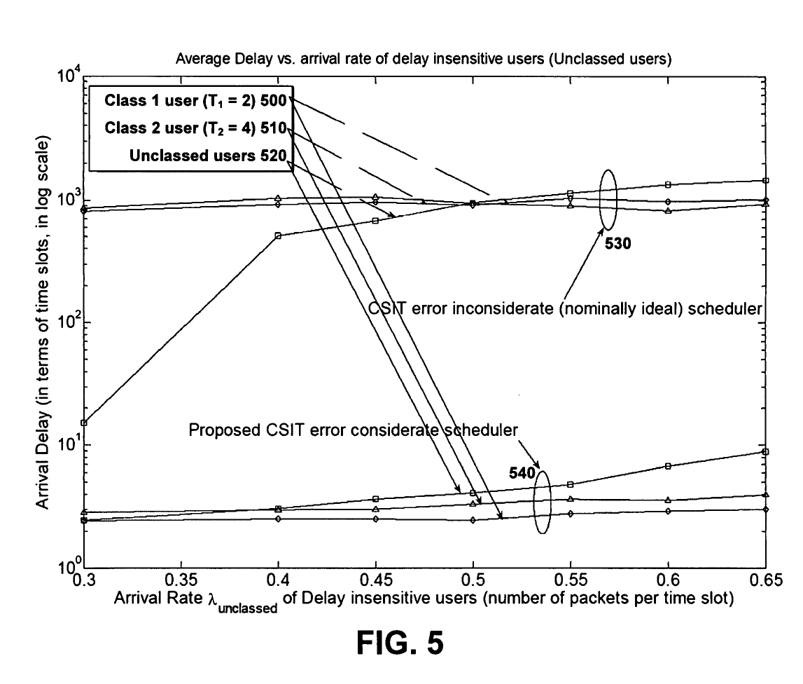

FIG. 5 shows average delay versus traffic loading of the background users under CSIT error conditions (σ_{ΔH}²=0.05)(P_{TOT}=11). For both CSIT error inconsiderate scheduling 530 and CSIT considerate scheduling 540 as described herein, three curves are represented corresponding to 3 classes of users: class 1 users 500, class 2 users 510 and unclassed users 520 (users with no class). While the nominally ideal scheduler cannot provide any delay constraint guarantee, the CSIT error considerate scheduler can satisfy the delay requirements of users of class 1 500 and users of class 2 510 regardless of background users' traffic loading. When background users' traffic loading increases, delay performance of the background users can degrade.

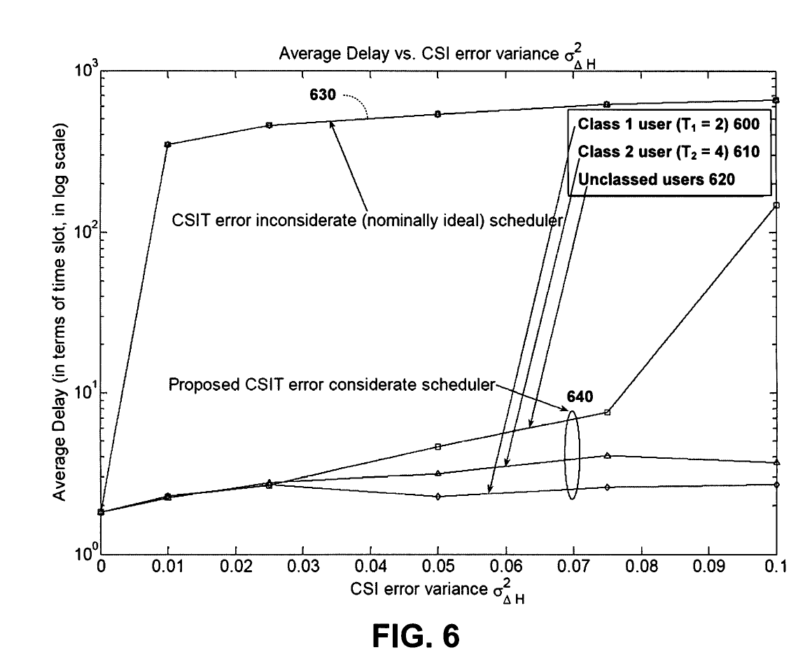

FIG. 6 shows the average delay performance versus CSIT errors (P_{TOT}=15). As shown, the performance for three classes of users, i.e., class 1 users 600, class 2 users 610 and unclassed users 620, are represented for the CSIT error considerate scheduling 640. In this regard, using the CSIT error inconsiderate scheduling 630, the delay performance of users degrades significantly even under conditions of low CSIT error variance. In contrast, with the CSIT error considerate scheduling 640, the delay constraints of classed users are satisfied even under moderate and high CSIT error variance. This robustness to CSIT errors introduced by the CSIT error considerate scheduler is significant for practical implementation of an OFDMA TDD system in which the outdated nature of CSIT is often not negligible.

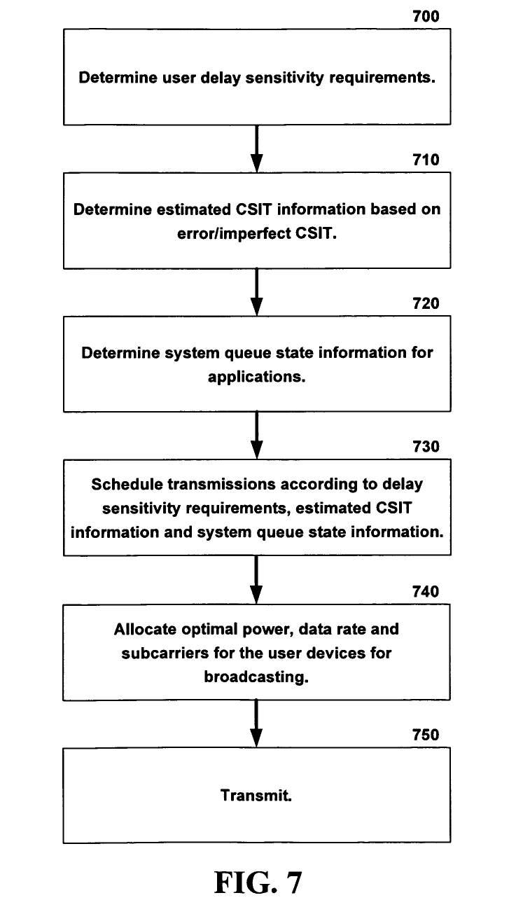

FIG. 7 is a flow diagram illustrating an exemplary, non-limiting process for scheduling from the perspective of a broadcast scheduler. At 700, a scheduler allocates power, data rate and subcarriers for an OFDMA system. At 710, the scheduler determines user delay sensitivity requirement for users, and also determines estimated CSIT information for the users based on outdated CSIT information received. At 720, system queue state information is also determined for the one or more applications requesting or sending data in the wireless communications system from the users. The system queue state information can include analyzing activity associated with application buffers.

Next, at 730, the scheduling results are formed based on the user delay sensitivity requirements specified by users, estimated CSIT information for the users, and the system queue state information for the applications. At 740, optimal power, data rate, and at least one subcarrier are allocated for a transmitter transmitting to the users based, at least in part, on the cross layer scheduling result. At 750, data is transmitted according to the allocation of step 740.

The optimal allocation includes optimizing average total throughput of the wireless communication system subject to the users delay sensitivity requirement. Diversity gain of the users increases at a rate of log(K) with the K users and decreases proportionally with CSIT error variance of the estimated CSIT information.

A system that implements the above process in an OFDMA system includes a cross layer scheduler component that allocates system subcarriers and power to form a transmission schedule for user devices based on CSIT error information and based on delay requirements specified by user devices. The system can include a broadcasting component that transmits to one or more users based, at least in part, on the transmission schedule. The cross layer scheduler component allocates power and system subcarriers to satisfy the delay requirements. The cross layer scheduler component allocates power and system subcarriers to satisfy a data rate imposed by the delay requirements. The cross layer scheduler component thus can guarantee a fixed target outage probability for the heterogeneous user devices.

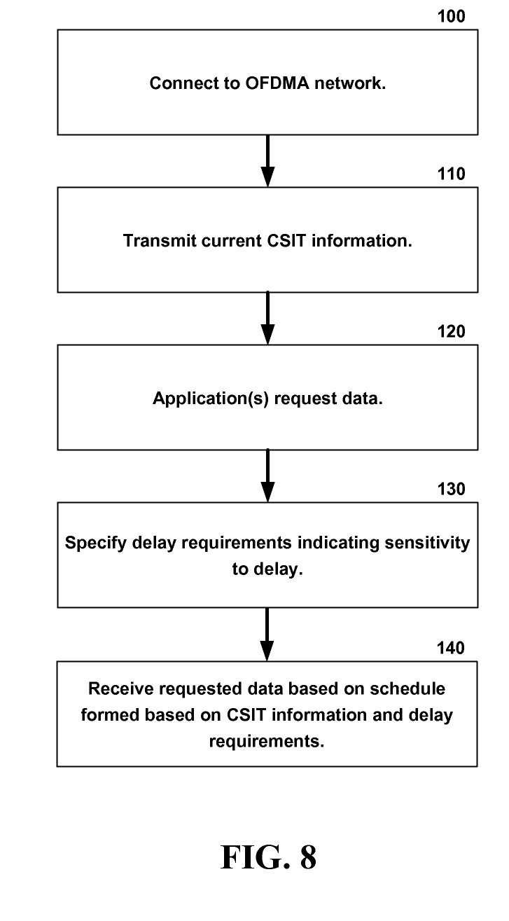

FIG. 8 is a flow diagram illustrating an exemplary, non-limiting process for scheduling from the perspective of users, illustrating a process for providing user access to heterogeneous user devices in an OFDMA system. At 800, a user device connects to an OFDMA network. At 810, the user device transmits current CSIT information by a user device. At 820, applications of the user device request to receive data. At 830, the user device can specify delay requirements indicating a sensitivity to delay for the data, and then at 840, the user device receives the data. The data is received according to a schedule that is based on the at least one delay requirement and based on an estimate of the current CSIT information transmitted by the user device given error in the current CSIT information.

In this regard, the allocation of subcarriers, power, and data rate resources is based on the at least one delay requirement and based on an estimate of the current CSIT information. As a result of the allocation, the data is received according to an optimal average total throughput of the wireless communication system subject to the users delay requirement.

Although not required, the claimed subject matter can partly be implemented via an operating system, for use by a developer of services for a device or object, and/or included within application software that operates in connection with one or more components of the claimed subject matter. Software may be described in the general context of computer-executable instructions, such as program modules, being executed by one or more computers, such as clients, servers, mobile devices, or other devices. Those skilled in the art will appreciate that the claimed subject matter can also be practiced with other computer system configurations and protocols, where non-limiting implementation details are given.

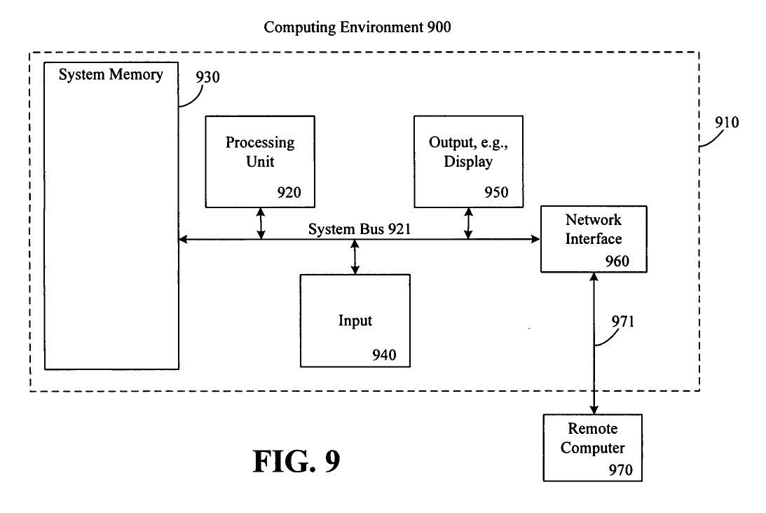

FIG. 9 thus illustrates an example of a suitable computing system environment 900 in which the claimed subject matter may be implemented, although as made clear above, the computing system environment 900 is only one example of a suitable computing environment for a media device and is not intended to suggest any limitation as to the scope of use or functionality of the claimed subject matter. Further, the computing environment 900 is not intended to suggest any dependency or requirement relating to the claimed subject matter and any one or combination of components illustrated in the example operating environment 900.

With reference to FIG. 9, an example of a remote device for implementing various aspects described herein includes a general purpose computing device in the form of a computer 910. Components of computer 910 can include, but are not limited to, a processing unit 920, a system memory 930, and a system bus 921 that couples various system components including the system memory to the processing unit 920. The system bus 921 can be any of several types of bus structures including a memory bus or memory controller, a peripheral bus, and a local bus using any of a variety of bus architectures.

Computer 910 can include a variety of computer readable media. Computer readable media can be any available media that can be accessed by computer 910. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media can embody computer readable instructions, data structures, program modules or other data in a modulated data signal such as a carrier wave or other transport mechanism and can include any suitable information delivery media.

The system memory 930 can include computer storage media in the form of volatile and/or nonvolatile memory such as read only memory (ROM) and/or random access memory (RAM). A basic input/output system (BIOS), containing the basic routines that help to transfer information between elements within computer 910, such as during start-up, can be stored in memory 930. Memory 930 can also contain data and/or program modules that are immediately accessible to and/or presently being operated on by processing unit 920. By way of non-limiting example, memory 930 can also include an operating system, application programs, other program modules, and program data.

The computer 910 can also include other removable/non-removable, volatile/nonvolatile computer storage media. For example, computer 910 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 921 through a non-removable memory interface such as an interface, and a magnetic disk drive or optical disk drive can be connected to the system bus 921 by a removable memory interface, such as an interface.

A user can enter commands and information into the computer 910 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 920 through user input 940 and associated interface(s) that are coupled to the system bus 921, but can be connected by other interface and bus structures, such as a parallel port, game port or a universal serial bus (USB). A graphics subsystem can also be connected to the system bus 921. In addition, a monitor or other type of display device can be connected to the system bus 921 via an interface, such as output interface 950, which can in turn communicate with video memory. In addition to a monitor, computers can also include other peripheral output devices, such as speakers and/or a printer, which can also be connected through output interface 950.

The computer 910 can operate in a networked or distributed environment using logical connections to one or more other remote computers, such as remote computer 970, which can in turn have media capabilities different from device 910. The remote computer 970 can be a personal computer, a server, a router, a network PC, a peer device or other common network node, and/or any other remote media consumption or transmission device, and can include any or all of the elements described above relative to the computer 910. The logical connections depicted in FIG. 9 include a network 971, such local area network (LAN) or a wide area network (WAN), but can also include other networks/buses. Such networking environments are commonplace in homes, offices, enterprise-wide computer networks, intranets and the Internet.

When used in a LAN networking environment, the computer 910 is connected to the LAN 971 through a network interface or adapter. When used in a WAN networking environment, the computer 910 can include a communications component, such as a modem, or other means for establishing communications over the WAN, such as the Internet. A communications component, such as a modem, which can be internal or external, can be connected to the system bus 921 via the user input interface at input 940 and/or other appropriate mechanism. In a networked environment, program modules depicted relative to the computer 910, or portions thereof, can be stored in a remote memory storage device. It should be appreciated that the network connections shown and described are exemplary and other means of establishing a communications link between the computers can be used.

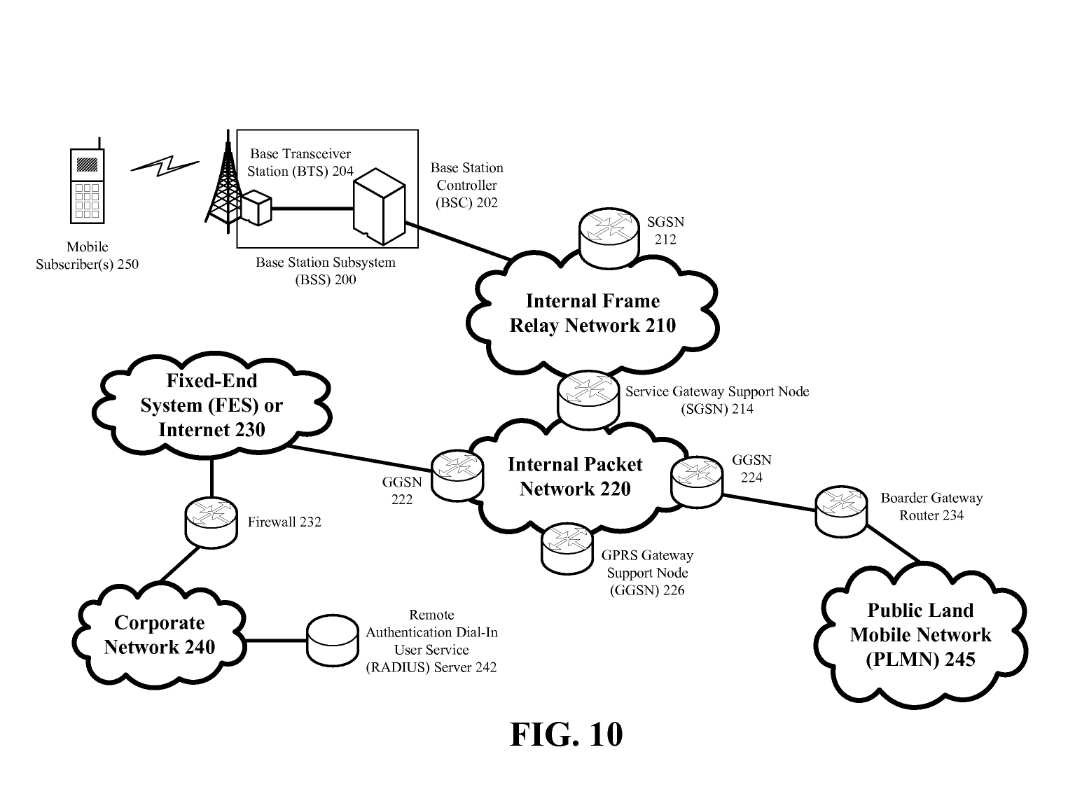

Turning now to FIG. 10, an overview of a network environment in which the claimed subject matter can be implemented is illustrated. The above-described systems and methodologies for timing synchronization may be applied to any wireless communication network; however, the following description sets forth an exemplary, non-limiting operating environment for said systems and methodologies. The below-described operating environment should be considered non-exhaustive, and thus the below-described network architecture is merely an example of a network architecture into which the claimed subject matter can be incorporated. It is to be appreciated that the claimed subject matter can be incorporated into any now existing or future alternative architectures for communication networks as well.

FIG. 10 illustrates various aspects of the global system for mobile communication (GSM). GSM is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the timing synchronization techniques described herein may be applied independently of the method of data transport, and does not depend on any particular network architecture or underlying protocols.

FIG. 10 depicts an overall block diagram of an exemplary packet-based mobile cellular network environment, such as a GPRS network, in which the claimed subject matter can be practiced. Such an environment can include a plurality of Base Station Subsystems (BSS) 1000 (only one is shown), each of which can comprise a Base Station Controller (BSC) 1002 serving one or more Base Transceiver Stations (BTS) such as BTS 1004. BTS 1004 can serve as an access point where mobile subscriber devices 1050 become connected to the wireless network. In establishing a connection between a mobile subscriber device 1050 and a BTS 1004, one or more timing synchronization techniques as described supra can be utilized.

In one example, packet traffic originating from mobile subscriber 1050 is transported over the air interface to a BTS 1004, and from the BTS 1004 to the BSC 1002. Base station subsystems, such as BSS 1000, are a part of internal frame relay network 1010 that can include Service GPRS Support Nodes (“SGSN”) such as SGSN 1012 and 1014. Each SGSN is in turn connected to an internal packet network 1020 through which a SGSN 1012, 1014, etc., can route data packets to and from a plurality of gateway GPRS support nodes (GGSN) 1022, 1024, 1026, etc. As illustrated, SGSN 1014 and GGSNs 1022, 1024, and 1026 are part of internal packet network 1020. Gateway GPRS serving nodes 1022, 1024 and 1026 can provide an interface to external Internet Protocol (“IP”) networks such as Public Land Mobile Network (“PLMN”) 1045, corporate intranets 1040, or Fixed-End System (“FES”) or the public Internet 1030. As illustrated, subscriber corporate network 1040 can be connected to GGSN 1022 via firewall 1032; and PLMN 1045 can be connected to GGSN 1024 via boarder gateway router 1034. The Remote Authentication Dial-In User Service (“RADIUS”) server 1042 may also be used for caller authentication when a user of a mobile subscriber device 1050 calls corporate network 1040.

Generally, there can be four different cell sizes in a GSM network—macro, micro, pico, and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, no single embodiment shall be considered limiting, but rather the various embodiments and their equivalents should be construed consistently with the breadth, spirit and scope in accordance with the appended claims.

What is claimed is:

1. A method for allocating power, data rate and subcarriers for a wireless communication system, comprising:
determining a cross layer scheduling result for at least one user in the wireless communication system based, at least in part, on at least one user delay sensitivity requirement specified by at least one user, estimated channel state information at the transmitter (CSIT) information for the at least one user, and system queue state information for one or more applications of the at least one user communicating data in the wireless communication system; and
allocating power, data rate, and at least one subcarrier for a transmitter transmitting to the at least one user based, at least in part, on the cross layer scheduling result determined for one or more users.

2. The method of claim 1, wherein the allocating includes optimizing average total throughput of the wireless communication system subject to the at least one user delay sensitivity requirement.

3. The method of claim 1, further comprising:
determining the at least one user delay sensitivity requirement for the at least one user.

4. The method of claim 1, further comprising:
determining the estimated CSIT information for the at least one user based on outdated CSIT information received from the at least one user of the wireless communication system.

5. The method of claim 1, further comprising:
determining the system queue state information for the one or more applications requesting or sending data in the wireless communications system from the at least one user.

6. The method of claim 5, wherein the determining of the system queue state information includes analyzing activity associated with at least one application buffer associated with the one or more applications.

7. The method of claim 1, whereby diversity gain of the at least one user increases at a rate of log (K) with the K users.

8. The method of claim 1, whereby diversity gain of the at least one user decreases proportionally with CSIT error variance of the estimated CSIT information.

9. A computer readable medium bearing computer executable instructions for carrying out the method of claim 1.

10. A system for providing user access to user devices in an orthogonal frequency division multiple access (OFDMA) system, comprising:
a cross layer scheduler component that allocates system subcarriers and power to form a transmission schedule for at least one of the user devices based on channel state information at the transmitter (CSIT) error information and based on at least one delay requirement specified by at least one of the user devices; and
a broadcasting component that transmits to one or more users based, at least in part, on the transmission schedule.

11. The system of claim 10, wherein the cross layer scheduler component allocates power and system subcarriers to satisfy the at least one delay requirement.

12. The system of claim 10, wherein the cross layer scheduler component allocates power and system subcarriers to satisfy a data rate imposed by the at least one delay requirement.

13. The system of claim 10, wherein the cross layer scheduler component guarantees a fixed target outage probability for the heterogeneous user devices.

14. The system of claim 10, wherein the scheduling component is provided in a broadcast station of the OFDMA system.

15. A method for providing user access to heterogeneous user devices in an orthogonal frequency division multiple access (OFDMA) system, comprising:
transmitting current channel state information at transmitter (CSIT) information by a user device;
requesting to receive data in the OFDMA system by one or more applications by the user device;
specifying at least one delay requirement indicating a sensitivity to delay for the data; and
receiving the data according to a schedule that is based on the at least one delay requirement and based on an estimate of the current CSIT information transmitted by the user device given error in the current CSIT information.

16. The method of claim 15, wherein the receiving of the data according to the schedule includes receiving the data according to a schedule from a scheduler that dynamically allocates system subcarriers, power, and data rate resources based on the at least one delay requirement and based on an estimate of the current CSIT information.

17. The method of claim 15, wherein the specifying includes specifying when connecting to the OFDMA system.

18. The method of claim 1, wherein the receiving of the data includes receiving the data according to an optimal average total throughput of the wireless communication system subject to the at least one user delay requirement.

19. The method of claim 1, wherein the receiving includes receiving the data according to a schedule that is based on queue state information corresponding to one or more applications of user devices in the OFDMA system.

20. A computing device comprising means for performing the method of claim 1.
